(19) United States
(12) Patent Application Publication
(10) Pub. No.: US 2006/0006823 A1
(43) Pub. Date: Jan. 12, 2006

(54) Method to control electric windows of automobiles by an activating button with two wires

(75) Inventor: Marcos Ferretti, Campinas (BR)

Correspondence Address: DINSMORE & SHOHL, LLP, 1900 CHEMED CENTER, 255 EAST FIFTH STREET, CINCINNATI, OH, 45202, US

(73) Assignee: PST INDUSTRIA ELETRONICA DA AMAZONIA LTDA., Manaus (BR)

(21) Appl. No.: 10/887,150

(22) Filed: Jul. 8, 2004

(51) Int. Cl. H02P 1/22; H02P 3/00

(52) U.S. Cl. 318/280

(57) ABSTRACT

A method to control electric windows for automobiles by means of an activating button with only two wires, where the electronic control module can enable/disable the activating button and interpret whether it has been pressed in the upward or downward direction of the automobile's window.

### FIELD OF THE INVENTION

The present invention relates to electric window control systems for automobiles.

### BACKGROUND OF THE INVENTION

There are numerous systems designed to control the activation of electric windows of automobiles. These systems can include a few basic components: the command buttons located inside the vehicle and accessible to its passengers, the electronic control and activating module, and the mechanism coupled internally to the vehicle's door which is responsible for closing/opening the vehicle's window.

These systems can be either automated or non-automated. The automated system has an electronic control and activating module, due to which, the vehicle's passenger does not need to press the electrical command button during all the way up or down of the window since, when it receives the command from the button (up or down), the electronic module supplies power to the electrical motor coupled to the mechanism until the window is completely opened or closed. In the non-automated system, the user must keep the button pressed in the window's up/down direction during the entire opening or closing sequence until the window is completely opened or closed. If the user depresses the activating button, the window will interrupt its course and will stop at an intermediary position. For these non-automated systems, the presence of the electronic control module occurs in some cases and in others not, where such presence is linked to the type of activating button that is used by the system, those with high current capacity or those with low current capacity.

Another distinctive characteristic of electric window activating control systems is the presence of the anti-pinch protection feature. The systems with the anti-pinch characteristic makes the window change its direction for a certain time when it encounters an obstacle that blocks or hinders its closing during its way up.

The foregoing systems mentioned all use command/activating buttons with a minimum of three wires. Having a larger number of wires used for each activating button will result in a greater cost for manufacturing the system, including the value of labor to manufacture the wire harness (a group of wires, terminals and connectors used to connect all the parts that make up the system) necessary to connect all the parts of the system.

### SUMMARY OF THE INVENTION

The invention provides a method to control electric windows for automobiles by means of an activating button interconnected to the electronic control module, using only two wires. The method, as it involves a minimum number of wires for connecting the command/activating button to the control module, lends the system a substantial cost reduction in the manufacture of the system's wire harness, as well as substantially decreasing the number of components present in the command/activating button intended to connect the wires. The method can also offer a cost reduction in the manufacture of a command/activating button to be used with the system described herein.

In one embodiment, the present invention provides a method to control the activating of electric windows for automobiles, using a button with only two connecting wires to connect to the electronic control module. The method involves the development of specific electronic circuits that allows the interpretation by the module control if the user activated the window's up or down command as well as enabling the button for the user to be able to activate it.

The features of the present invention will become apparent to one of ordinary skill in the art upon reading the detailed description, in conjunction with the accompanying drawings, provided herein.

### BRIEF DESCRIPTION OF THE DRAWINGS

FIG. 1 is a simplified block diagram of an electric window operating system according to the present invention.

FIG. 2 is a circuit diagram implemented inside the activating electronic control module. This circuit is responsible for enabling the system's command buttons and for the interpretation of the window's activating direction, according to the user's command (up or down).

FIG. 3 is a circuit diagram implemented within the system's command/activating electric window control button.

### DETAILED DESCRIPTION OF EMBODIMENTS OF THE INVENTION

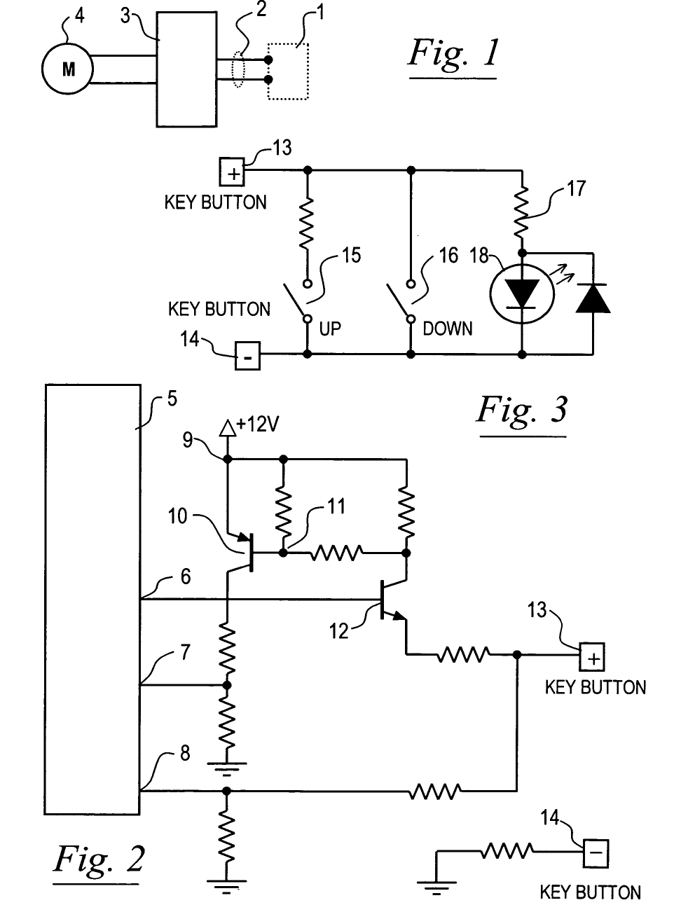

In accordance with the teachings of the present invention and with reference to FIG. 1, there is shown a command/activating button 1 localized inside a vehicle and accessible to the vehicle's passenger (user), an electronic control module 3 and an electrical motor 4 coupled to the vehicle's window moving mechanism.

The command/activating button 1 has two activating positions, one to indicate the window's upward command and another to indicate the window's downward command. The activating button 1 is connected to the electronic control module 3 by means of a pair of conducting wires 2.

In order to allow the user to command the vehicle's window (up or down) by activating the command button 1, the electronic control module 3 can enable (activate) the command button 1. This is possible through a microcontroller 5 that controls the system's electronic control module 3. For this, the microcontroller 5 makes available a high-logic level voltage, approximately 5 volts, at a control pin 6. This makes an NPN transistor 12 enter into conduction and supply current to the activating button 1 through a contact 13, thereby allowing the button 1 to be enabled and the light emitting diode (LED) 18 be lit (the lit LED shows that the command button has been enabled). With the command button 1 enabled, the user can command the rising and lowering of the vehicle's window. If the command button 1 is not enabled, i.e., the voltage at the control pin 6 has a low logic level, the command button 1 is not enabled. If the user presses the command button 1 either in the upward or downward direction, the control module 3 does not energize the motor 4 and, consequently, the window does not move.

In the case where the command button 1 is enabled, i.e., the voltage at the control pin 6 is at high logic level, and that the user is not pressing the command button 1 (the button is at rest), there is a determined level of electrical current flowing between the circuit's nodes 13, 14, which is given by the LED 18 and the resistor's value 17. It is important to emphasize that the pair of conducting wires 2 indicated in FIG. 1 perform the connection of the nodes 13, 14 between the circuits shown in FIG. 2 and FIG. 3. The level of current established can be insufficient to make the electrical voltage between the nodes 9, 11 be a sufficient value so that a PNP transistor 10 enters into conduction, i.e., the voltage between the nodes 9, 11 is below 0.7 volts. With the PNP transistor 10 at cut status, the voltage at the pin, called an “activating” pin 7, is approximately equal to zero volts. When the microcontroller 5 reads the activating pin 7, it will then detect that the command button is not activated, due to the fact that the voltage at this pin 7 is at a low logic level.

With the activating button 1 enabled, if the user presses it in the upward or downward direction, thereby closing the switches 15, 16, respectively, there is an increase in the electrical current flowing through the NPN transistor collector 12 which allows the voltage between the nodes 9, 11 to be higher than 0.7 volts, i.e., the PNP transistor 10 enters into conduction and, therefore, the logic level of the activating pin 7 is high, indicating to the microcontroller 5 that the activating button has been pressed in the upward or downward direction.

The microcontroller 5 can determine whether the activating button 1 has been pressed in the upward direction (switch 15 is closed) or downwards (switch 16 is closed) by means of the logic level read at the pin called “value” 8. The decision threshold of the pin 8 of the microcontroller 5 is known, i.e., above which voltage the microcontroller 5 interprets the signal as being a high logic level signal and below which voltage the microcontroller 5 interprets the signal as being a low logic level signal. The limit voltage level for interpreting the logic levels is referred to as the “threshold voltage.”

Referring to FIG. 3, the activating button 1 is enabled and it is pressed in the upward direction, thereby closing switch 15. At that moment, an additional current to the current drained by the branch, which contains the enable indicating LED, will flow between nodes 13, 14. This current will indirectly make the voltage level at the activating pin 7 go to a high logic level, indicating, therefore, that the activating button 1 has been activated (either in the upward or downward direction), as described previously. In this situation, the voltage at the value pin 8 will be greater than the “threshold voltage” and then the microcontroller 5 will interpret that the activating button 1 has been activated in the upward direction.

In the situation where the activating button 1 is pressed in the downward direction (thereby closing the switch 16 shown in FIG. 3), there is a short-circuit situation between nodes 13, 14. In this situation the activating voltage at pin 7 will also be at a high logic level (button activated) and the voltage at the value pin 8 will be lower than the “threshold voltage,” making the microcontroller 5 interpret the signal at this pin as being at a low logic level, indicating, therefore, that the activating button 1 has been pressed in the window's downward direction.

Choosing the proper values of the resistors involved in the circuits of FIGS. 2 and 3, it is possible to use up to two activating buttons connected in parallel for each electrical window motor to be commanded.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

While the invention is described herein in connection with certain preferred embodiments, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. The inventors expect skilled artisans to employ such variations as appropriate, and the inventors intend for the invention to be practiced otherwise than as specifically described herein. Accordingly, the intent is to cover all alternatives, modifications, and equivalents included within the spirit and scope of the invention. Moreover, any combination of the above-described elements in all possible variations thereof is encompassed by the invention unless otherwise indicated herein or otherwise clearly contradicted by context.

1. A method to control electric windows of automobiles comprising the steps of:
(a) using an electric window activating/command button for lifting and lowering the vehicle's window, said button having at least two activating positions and a resting position, said button comprising an internal illumination device configured to provide illumination, wherein said button is connected to an electronic control module by a pair of electrical conducting wires; and
(b) by means of said two wires and the electronic module, activating the internal illumination device, enabling and disabling the activating button and interpreting in which activating position the button has been pressed for upward or downward movement of the vehicle's window.

2. The method in accordance with claim 1, wherein the interpretation of the activating position of the activating/command button by the electronic control module is based on two different electrical current consumption levels between connecting terminals of the activating/command button, the two levels corresponding to the two activating positions, the activating positions controlling upward or downward direction of the vehicle's window.

3. The method in accordance with claim 1, wherein the electronic control module detects if the activating/command button has been activated or is in the resting position.
